(19) United States
(12) Patent Application Publication
(10) Pub. No.: US 2017/0024603 A1
(43) Pub. Date: Jan. 26, 2017

(54) BIOMETRIC IMAGE OPTIMIZATION USING LIGHT FIELDS

(71) Applicant: Anthony Ray Misslin, Milford, MA (US)

(72) Inventor: Anthony Ray Misslin, Milford, MA (US)

(21) Appl. No.: 15/212,444

(22) Filed: Jul. 18, 2016

Related U.S. Application Data
(60) Provisional application No. 62/195,510, filed on Jul. 22, 2015.

(51) Int. Cl. G06K 9/00

(52) U.S. Cl. CPC G06K 9/00026; G06K 9/00604; G06K 9/00892

(57) ABSTRACT

The application of light field imaging in the capture of biometric images enables image processing to use continuous focus adjustment of a single image to construct an image of a biometric feature that is in focus across an expanded depth of field. Because a single image is the source of all information, the final image is formed without requiring combination of multiple images that may have physically moved between capture of the images. Light field imaging can be accomplished through multiple methods including plenoptic cameras or focus stacking cameras. The use of near infrared wavelengths in images captured using light fields optimizes the deployment of biometric systems by eliminating intense visible light currently implemented to capture some biometrics. The use of near infrared wavelengths for light field imaging enhances iris capture as the iris display more useful characterization under near infrared illumination.

### CROSS REFERENCE TO RELATED APPLICATIONS

This application claims the benefit of provisional application, U.S. Ser. No. 62/195,510 filed on Jul. 22, 2015, entitled Biometric Image Optimization using Light Fields, by Anthony R. Misslin.

Related documents, see patents shown for related information:
U.S. Pat. No. 8,760,566, Video refocusing
U.S. Pat. No. 8,860,833, Blended rendering of focused plenoptic camera data

### BACKGROUND OF THE INVENTION

Technical Field

Biometrics is the technology that uses body characteristics unique to each individual to uniquely identify that person. Biometric characteristics currently include DNA, vein patterns, fingerprints, eye retinas and irises, voice patterns, facial patterns and hand measurements but new definitions continue to evolve. These biometric characteristics identify an individual even if incorrect demographics are given such as false name or date of birth.

Biometric solutions employ a device for capturing biometrics, software that converts the scanned information into digital data, a database or single stored image, and an algorithm for verifying if a probe image matches the stored image(s). These images are used by information technology, information security, and public security.

An important aspect of information technology and information security is authentication of the subject accessing a system. Authentication by biometric verification is accomplished by storing the individual's biometric data in a system and comparing it to information provided by the individual wishing to be authenticated. Biometric verification is currently used for physical access control (e.g., building entrances, sporting and entertainment venues, airport and border control checkpoints, visa/passport verification) and logical access control (e.g., computer or cell phone log in, point of sales, or mobile payments).

Public security often requires identification of individuals. Almost all biometric booking stations today include livescan capture of fingerprints, palm prints, facial images (frontal and profile), and will soon be collecting iris images. Images from these booking stations are used to populate databases which can in turn be searched. There are three major biometric databases in place in the United States: the Federal Bureau of Identification Next Generation Identification, the Department of Homeland Security IDENT system, and the DoD Automated Biometric Identification Systems (DoD ABIS). Law enforcement uses these databases to accurately identify individuals and to tie information from crime scenes to individuals. Defense Departments, public companies, schools, and other agencies conduct searches against these databases as part of pre-employment background checks. These systems are also used in the visa and passport application process. There are also biometric databases established in almost every state and major county in the United States, as well as around the world.

### Finger Print Image Capture

The primary biometric used in the past has been the fingerprint. Collection of fingerprints began using a method of rolling the fingers on an ink pad and then repeating the motion on a paper card. The ink and paper method did an excellent job in most cases but was subject to the skill of the person taking the prints as well as the cooperation of the subject whose prints were being taken. Any flaw during the process could result in starting over. Originally, use of the fingerprints was done comparing the card directly to a second card that was obtained through evidence generation or recapture of the individual. The ability to scan or digitize these cards allowed the automation of matching against these prints using Automated Fingerprint Identification Systems, or AFIS.

Livescan systems, which date back to patents filed in 1964, use images from fingerprints placed on a glass platen to generate digital images that can be searched. These systems have issues with rolled prints. The rolled print requires capture of the image via multiple frames in order to combine the sides of the finger with the front of the finger. This requires logic or algorithms to ensure that the frames are joined seamlessly. This is referred to as stitching. Any rotational or sliding motion of the finger can cause errors in joining the frames. The result is the loss of features or creation of features, referred to as false minutiae, which do not represent those in the fingerprint. The use of higher frame rates enables a more accurate capture of the print but does not guarantee that all false minutiae have been eliminated.

Recently, cameras operating in the visible light range have demonstrated the ability to do direct capture of fingerprints, also referred to as contactless fingerprinting. This method of scanning currently does not yield the same image quality as livescan but has the advantage of being able to capture all four finger images from a single photo. The use of four fingers improves matching. Challenges with using typical cameras center around the need to capture multiple images that are not simultaneously in focus. Using multiple images requires a complex compilation of images verified against each other to ensure images are properly assigned to the fingers of the individual, a process known as sequence checking. Once properly sequenced, the surface of the fingerprint used is limited to that portion of the finger that is in focus.

Some applications, such as high traffic areas with subjects sensitive to bright lights or covert missions conducted at night, have shown issues caused by the bright light in the visible range required to do direct capture of fingerprints. These applications require alternative lighting to accomplish the capture.

### Palm Print Image Capture

Palm print history has followed a path similar to fingerprints, evolving from ink and paper to large size platens which enable livescan of palms. A different issue arises in the capture of palm prints in that the curvature or cup of the hand varies from individual to individual. In livescan capture, this often causes loss of capture over a significant portion of the palm. The capture of the palm using direct capture, or contactless capture, of palm prints presents a separate issue in that the same area that would be missed using livescan is often not in focus at the same time as the rest of the palm.

### Iris Image Capture

The iris of the eye may be the ideal biometric characteristic for identification and verification. While the uniqueness of the iris was observed by the ancient Egyptians and Greeks and iris as a biometric was proposed in the 1950s, John Daugman proposed the basis of current iris recognition in a patent filed in 1991. Current algorithms yield false match rates less than 10⁻¹¹ at extremely high speeds (650 trillion comparisons a day in India) enabling databases of extremely large populations. India and Malaysia have deployed national iris systems intended to grant social privileges and limit fraud. The US DoD and NATO have added iris databases to counter terrorists. Iris is widely deployed for access control, including wide-scale usage in the Middle East for border control at airports and remote entry stations. Driven by the FBI Next Generation Identification which added iris to their biometric identification capability, US Law Enforcement is beginning to include iris capture in booking locations.

Currently deployed iris matching systems operate using light in the Near Infrared (NIR) wavelengths. While light in the visible wavelength (VW) can be used for matching iris, matching performance is significantly increased in the NIR range for current algorithms.

Requirements for iris capture vary based on the application. Access control systems, where the subject needs to be enrolled to get access and is therefore cooperative, generally have operator interaction with the subject to enable iris capture in a controlled environment. Capture parameters (i.e., lighting, distance to the subject, stationary, etc.) are well controlled and the operator is able to adjust capture devices and subject position to ensure the images captured are high quality. Booking stations for law enforcement is similarly controlled with the exception that the subject is often uncooperative, either by choice or state of awareness.

Mobile iris capture systems have a more complex requirement in that the conditions of capture are less controlled and the subject is often uncooperative and potentially dangerous. The ability to capture a high quality iris is primarily driven by the distance to the subject and the environment where the subject is located. The farther the distance from the subject and more NIR emitted by the environment, the higher the level of NIR energy required for illumination by the sensor. In a very hot environment, objects that have residual heat in them may be reflected by the iris creating noise in the iris image. In addition, a subject's ability to open their eyes to reveal the iris may be hindered if the environment includes very bright light (i.e., bright sunshine). Some sensors implement a hooded device to shield the eyes to overcome the environment. This introduces depth of field issues in that a fixed focal length camera located close to the eyes may not have sufficient depth of field to overcome variations in forehead slant, eye socket, or bridge of the nose dimensions. Devices with sufficient depth of field require a longer focal length resulting in physically larger devices. Variable focus approaches, such as a voltage controlled lens, are feasible but require continuous capture of frames or real time quality checks. Alternative to a hooded sensor approach, stand-off devices use pulsed LEDs in the NIR range to generate sufficient energy to overcome noise from objects in the environment. These systems require other actions, typically procedural, to enable the subject to open their eyes sufficiently in bright light.

There are several devices on the market today to capture iris images. In its simplest form the capture device uses a fixed focal length camera with a mechanical means of setting the distance to the subject. These devices require a longer focal length and sufficient distance from the sensor to the subject to allow an acceptably linear image capture.

By modifying the sensor to provide feedback to the subject the sensor enables either the operator or the subject to adjust the capture device distance to optimize the captured image quality without requiring a fixed distance. Depth of field is less critical on these sensors. Some devices have the operator move the device or iris through a range of distances and automatically select the iris image with optimal focus of the images captured. Optimal focus is determined either using quality checks or the relative size of specular reflections of the device NIR sources (LEDs) by the pupil. The algorithms for selecting the image to be used show sensitivity to angle of capture, reflections from other NIR sources in the environment, and motion encountered during the capture.

Capture devices with variable focus capability capture a series of images while adjusting focus. Again, optimal focus is determined by algorithms to select the iris image with best focus. Variable focus has been attained using liquid lenses controlled by variable voltage or deformable mirrors using voice coil actuators. These implementations have limitations with operating temperature and reliability or are expensive to implement.

### Scars, Marks, And Tattoos

Scars, Marks, and Tattoos (SMT), have historically been used by law enforcement as a means of identifying subjects, primarily through biographical description. The digital collection of SMT for use in matching is still in its infancy. The Federal Bureau of investigation has begun collecting tattoo images to conduct tests on the automated processing of tattoos. This process will be very similar to the identification of facial images using Skin Texture Analysis (scars or marks) where the control of the image capture, both for the database image and the search probe, will drive whether useful matching can be performed. Images captured using surveillance or real time screening will be the source of most applications of SMT matching and success will be driven by the ability to overcome issues of low resolution, poor lighting, out of focus images, images at poor angles, or images from cameras that are located poorly.

Skin Texture is a secondary biometric based on a disfiguration or remarkable skin texture features present on a subject, similar to Marks. Skin texture is a strong parameter that adds confidence if the feature is found on both probe and potential matching images from the database. Lack of skin texture features does not necessarily eliminate potential matching subjects as skin texture can change over time (scars, moles, burns, etc).

### SUMMARY OF THE INVENTION

In accordance with the improved technique, implementing light field image capture in either the visible or near infrared wavelengths enables a single image capture of a biometric to include multiple views of the biometric with multiple planes of focus and multiple viewing angles. Light field imaging overcomes issues described in the background, improving the images captured and providing ability for post processing of the biometric image to obtain additional system performance. Combining information from multiple planes of focus and multiple viewing angles increases the biometric information available in a single biometric image.

### BRIEF DESCRIPTION OF THE DRAWINGS

The advantages of the techniques summarized above will be apparent from the detail description of particular arrangements as illustrated in the accompanying drawings. The drawings are not necessarily to scale, the emphasis being instead placed upon illustrating the principles of various arrangements of the novel techniques.

FIG. 1 illustrates the basis of light field theory and the plenoptic function as a characterization of light in space based on five dimensional parameters; position (x, y, z) and direction (θ, φ).

FIG. 2 shows the elements of the invention, including a capture device, processing, and database.

FIG. 3 illustrates the use of multiple planes of focus to build an image with each segment brought into focus using a dedicated light field view.

FIG. 4 illustrates the ability to extend the image of a fingerprint into a three dimensional image by using views from independent angles.

FIG. 5 illustrates multiple fingers (up to four per image) with each finger brought into focus using a dedicated light field view.

FIG. 6 illustrates the use of multiple planes of focus to build a palm print image with each segment brought into focus using a dedicated light field view.

FIG. 7 illustrates the use of multiple planes of focus to determine the optimal light field image view to obtain focused iris images.

FIG. 8 illustrates the use of multiple planes of focus to bring facial features, similar to Scars, Marks, Tattoos, and Skin Texture, into focus using multiple light field views.

FIG. 9 illustrates the ability to extend an image of a subject into an image with enhanced features that can be used to enhance Scars, Marks, Tattoos and Skin Texture by using multiple views containing different planes of focus and multiple viewing angles.

### DETAILED DESCRIPTION OF THE INVENTION

### Light Fields And Light Field Image Capture Devices

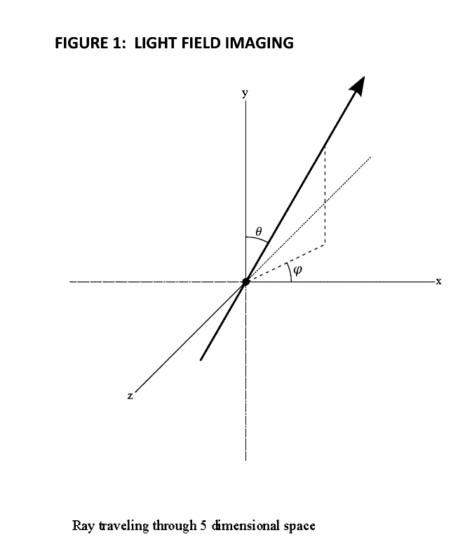

Light fields describe the amount of light flowing in every direction through every point in space. FIG. 1 illustrates the basis for light field theory. In 1991 E. H. Adelson defined the plenoptic function. The idealized “plenoptic illumination function” is used to express the image of a scene from any possible viewing position at any viewing angle at any point in time. Plenoptic cameras use micro-lens arrays or films placed in front of or behind a digital camera sensor to record images that contain information with multiple views from unique positions and angles with unique focal lengths. Focus stacking cameras use multiple images stored within a single image to implement similar results. Light field sampling, the number of views provided and resolution of each view, for a proposed solution is driven by the parameters, in this case biometric parameters, being operated on and the issue being resolved.

Plenoptic cameras that implement light field imaging are provided by multiple vendors (Lytro, Raytrix, Mitsubishi, Adobe) with various mechanisms. Focus stacking cameras are claimed by multiple vendors (Futurewei Technologies, Digitaloptics Corporation Europe Limited). The use of plenoptic or focus stacking cameras result in a single image capture that can take advantage of multiple views during post processing to provide clear focus of specific areas of the image or change the angle of view to obtain information otherwise not available in a two dimensional image. The operator or algorithm processing the image can sequence multiple views to extract the portion of each view that is in focus and combine the areas to obtain a full image that is in focus. This is accomplished without having to match edges of each area in focus since they are all views taken from the same image.

The application of the invention is described in the following paragraphs with variations based on the type of biometric parameter captured.

### System Overview

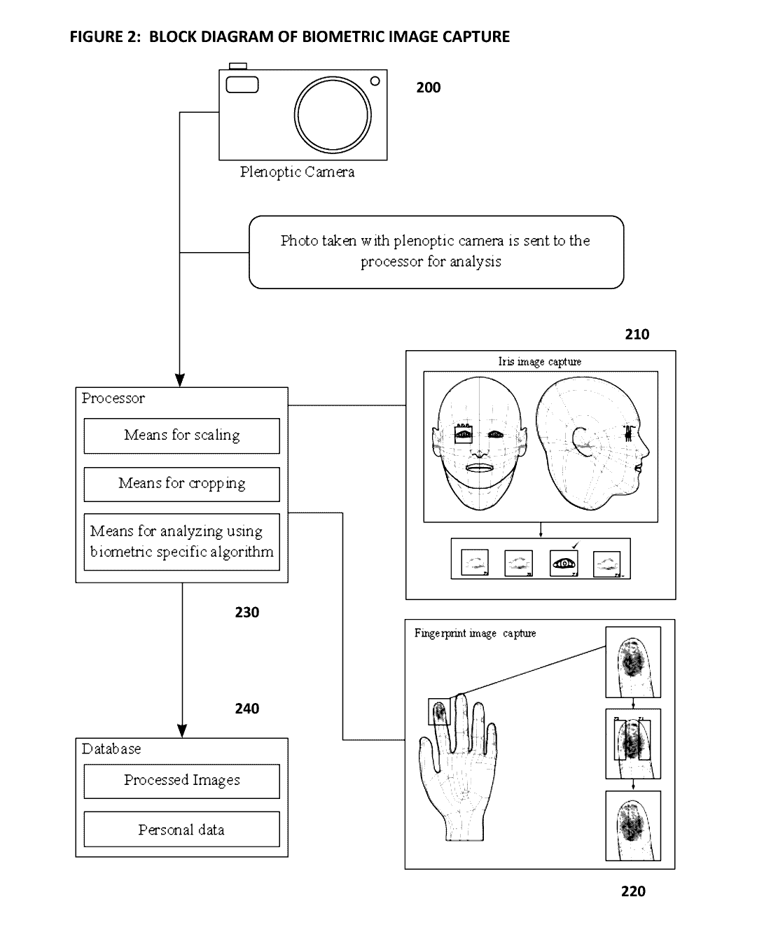

The invention is comprised of a high density camera with a means of implementing light field imaging, either through a plenoptic camera or focus stacking camera, and applying the methods described in the claims to the views contained within the resulting images in a manner that either eliminates the issues described in the background, improves the images as compared to images captured with conventional cameras, or provides ability for post processing of the biometric to obtain enhanced system performance. FIG. 2 illustrates an exemplary system which implements a plenoptic camera 200 to capture an image of an iris 210 or fingerprint 220 and subsequently post processes the image 230 to optimize the image before storing it in a database 240.

The proposed solution for each issue identified in the background can include implementation at the embedded hardware level with processing built into the sensor or may require a user interface for manipulation of the image on a portable device such as a cell phone or on a computer graphics terminal or workstation. The implementation is discussed for each biometric application in the detailed description.

### Finger Print Image Capture

The methods of using light field imaging to improve fingerprint capture are applicable to the direct capture, or contactless capture, of fingerprints. Three methods of the invention are proposed for the purpose of fingerprint capture. All three methods can be applied at either visible or at near infrared wavelengths;

Combining portions of single fingerprints captured in a single plenoptic photo or focus stacked images containing views with independent planes of focus to extend the area of the fingerprint image that is in focus.

Combining portions of single fingerprints captured in a single plenoptic photo or focus stacked images containing views with multiple viewing angles to extend the area of the image that is viewed.

The capture of multiple fingerprints on different planes using a single plenoptic photo or focus stacked images containing multiple views with independent planes of focus. Each finger is located in the image. Once an initial view of all fingerprints is established and each fingerprint located within the image, the method described above is applied to the area of each fingerprint separately and that area of the image is saved. Processing each individual fingerprint separately results in each fingerprint image being in focus.

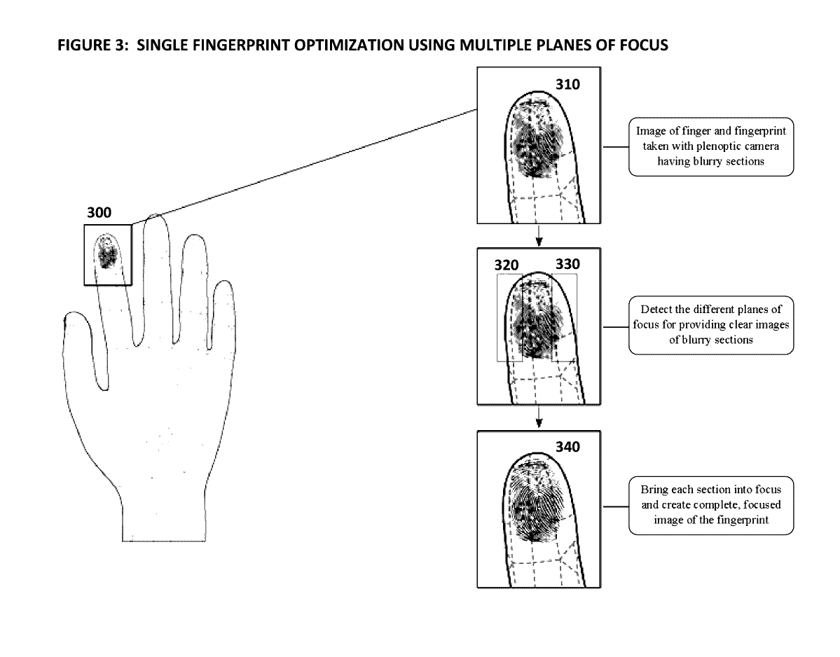

FIG. 3 illustrates the use of multiple views with independent planes of focus to construct a single image with an area in focus larger than an image captured from a single plane of focus. The method establishes a view containing a plane of focus through the fingerprint 300 and 310. The algorithm then selects views which bracket the fingerprint using multiple planes of focus in front of 320 and behind 330 the initial plane of focus. The algorithm determines the area of the image that is in focus in each view and saves this area. As each view is processed the portion in focus is added to the final image of the fingerprint 340.

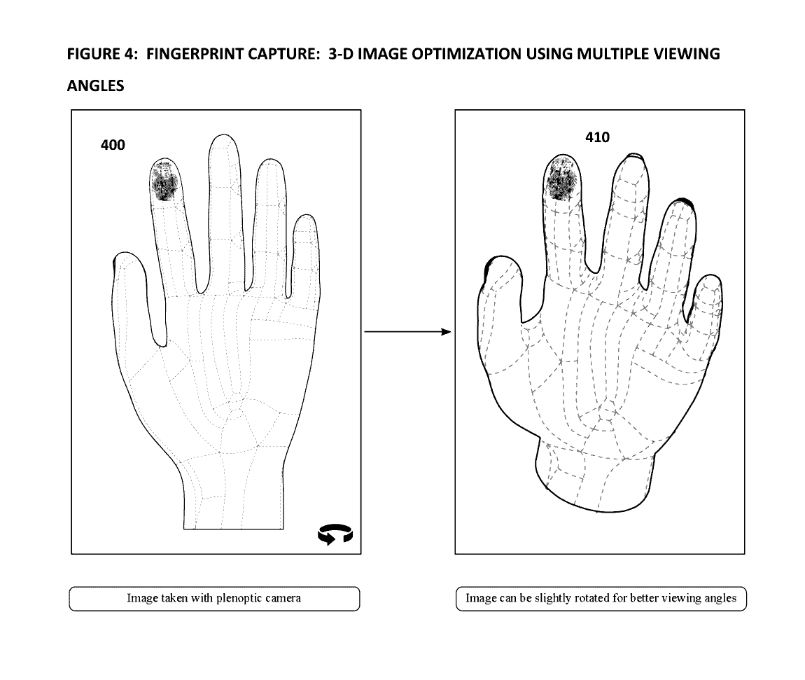

FIG. 4 illustrates the use of multiple views with independent angles of view to construct a single image that extend a view into a three dimensional representation of a single fingerprint. The fingerprint 400 is captured by a plenoptic camera perpendicular to the plane of the print. Because plenoptic cameras can provide multiple views from a single image they are able to select a view that shows a slightly rotated image 410 of the finger. Implementing an algorithm to flatten the three dimensional image into a single plane will enable use of the image equivalent to rolled prints collected today. The use of multiple views is an enhancement over typical biometric applications such as rolled fingerprints which require combining multiple frames of a moving fingerprint in order to create the rolled print. There is opportunity for the print to slip or move beyond the point that the edges can be matched from frame to frame resulting in a discontinuity (ridge break) in the image. Algorithms that smooth this discontinuity run the risk of creating information resulting in false or missing minutiae. For systems using light field images, the image is reconstructed from a single frame.

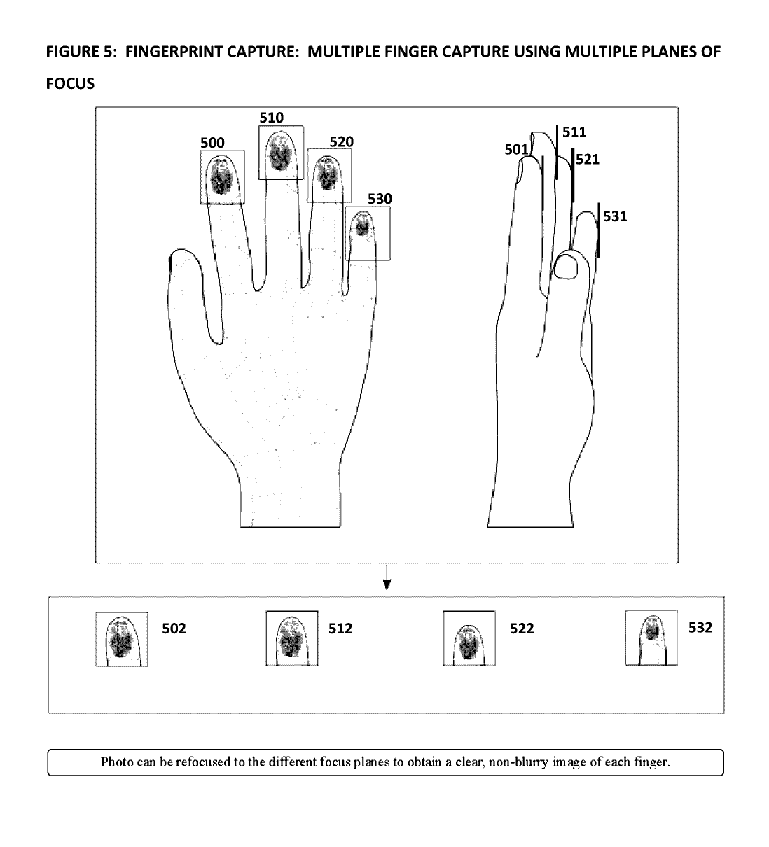

FIG. 5 illustrates the direct capture of multiple fingerprints (up to four) 500, 510, 520, 530 where each finger is located on a separate plane of focus 501, 511, 521, 531. The method first locates all fingerprints in the image and then sequences through the views provided by the plenoptic or focus stacking camera to select a view in which a plane of focus intersects each finger. Each finger can then be processed independently as described above to provide enhanced images for each finger 502, 512, 522, 532.

The application of these methods to direct capture or contactless capture can be illustrated through multiple examples. The direct capture or contactless capture of fingerprints for mobile identification for law enforcement using latest generation of cellular phones has been demonstrated by multiple providers. The key element in mobile identification for law enforcement is the ease of use and speed of capture as any delays take focus away from the officer and raise tension in the subject causing an officer safety issue. Current examples can take ten seconds or more to capture multiple fingers and require the officer's focus on the image on the phone screen. The use of the plenoptic or focus stacking camera allows the officer to ensure all four fingers are on the screen, allow the camera to autofocus once, and capture the image. The methods described above allow the image to be post processed using multiple views to obtain the plane of focus of each finger and then enhance each fingerprint image without requiring the attention of the officer.

Direct capture for access control and border control in airports, including checkpoints, boarding gates, and baggage claims, will require similar speed. The ability to place the four fingers of one hand over a contactless capture device for the same amount of time as one places a boarding pass today enables the use of fingerprints not only for entry into a country but also makes exit programs feasible by tracking subjects as they board or exit the aircraft. This application can also take advantage of near infrared illumination to eliminate sensitivities to bright light for subjects going past checkpoints or boarding gates. Direct capture of fingerprint images requires intense lighting on the fingers to enable sufficient dynamic range within the image to resolve noise and frequency requirements using a digital camera. The bright light required in the visible range is sufficient to trigger negative reactions in operators or subjects that are sensitive to flashes or intense lighting. The application of near infrared illumination in a pulsed mode, similar to a flash, eliminates this sensitivity. It also allows the use of screens which filter infrared light while allowing visible light to be used to enable subjects to view where to locate their hand without being affected by the near infrared flash.

### Palm Print Image Capture

Light field imaging using plenoptic or focus stacking cameras allows the use of multiple views to produce an image of a traditional palm print and add information from multiple views with planes of focus behind the platen to capture the cup of the hand. The portion of each view that is in focus can be combined to form a complete image of the palm.

The use of near infrared illumination in a pulsed mode eliminates the traditional bright light required in the visible range that often triggers negative reactions to operators or subjects that are sensitive to flashes or intense lighting. It also allows the use of screens which filter infrared light while allowing visible light to be used to enable subjects to view where to locate their hand without being affected by the near infrared flash.

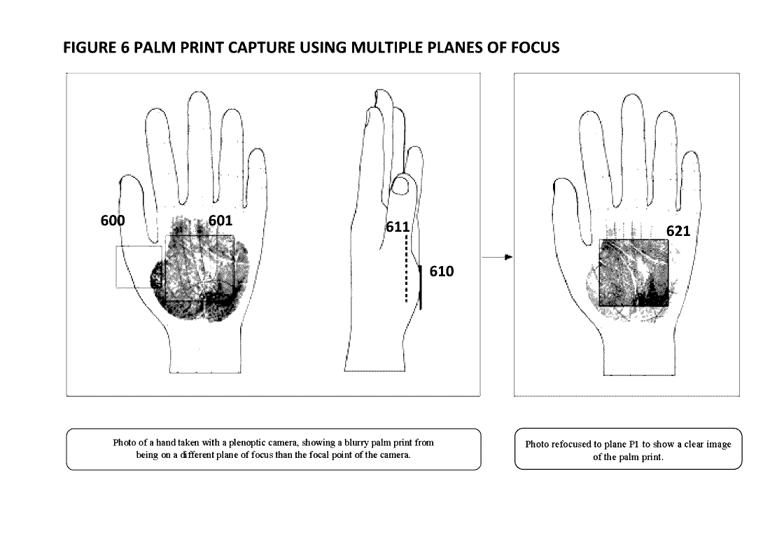

FIG. 6 illustrates the use of multiple views with independent planes of focus to construct a single palm print image with the cup of the hand in focus. The method selects a view with an initial focal plane that contains a portion of the palm 600 in focus. This image potentially leaves the cup of the hand 601 out of focus. The algorithm then selects views which bracket the palm using multiple planes of focus 611 behind the initial plane of focus 610. The algorithm determines the area of the image that is in focus 621 in each view and saves this area. As each view is processed the portion in focus is added to the final image of the palm print.

The use of plenoptic or focus stacking cameras removes the need for pressure on the hand to capture the cup of the palm (often unsuccessful) or the need for curved surfaces which add significant expense to the capture device.

### Iris Image Capture

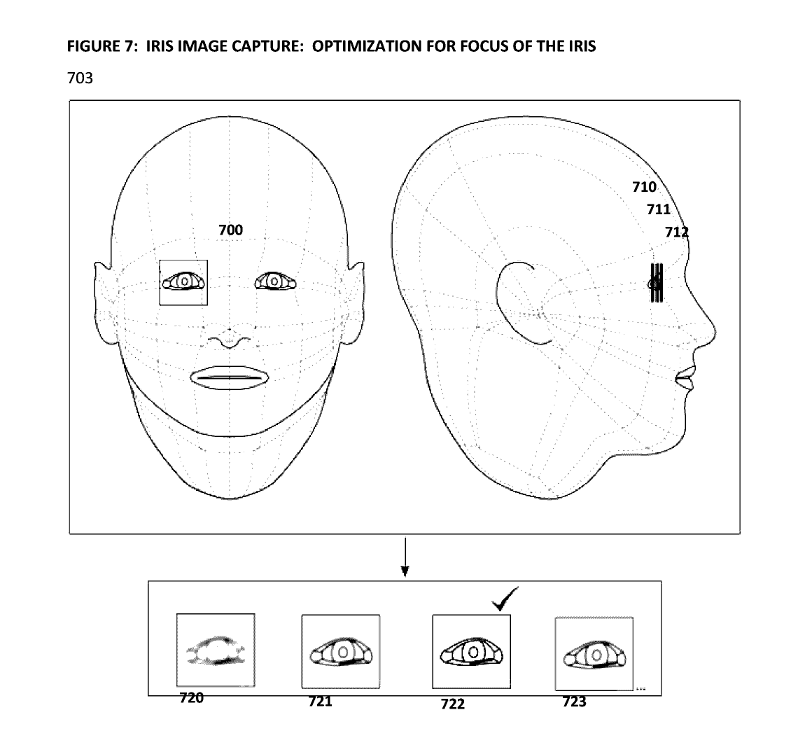

Plenoptic or focus stacking cameras have a unique ability to effectively increase the depth of field of a camera by using a single image with multiple views at varying planes of focus. This ability can be implemented as illustrated by FIG. 7 wherein the iris (or irises) 700 to be captured are located in an image which includes multiple views with varying planes of focus that bracket the iris. By sequencing through views containing different planes of focus 710, 711, 712 or more, evaluating each image 720, 721, 722, 723 and selecting the single view 722 with best meets image quality characteristics (often identified by the view wherein the size of an iris feature is minimized), the optimal view of the iris can be identified and saved.

The ability to sequence through multiple views from a single image captured with the plenoptic or focus stacking camera eliminates the need to move the iris capture device to simulate a larger depth of field or have the subject relocate to the optimal plane of focus. This capability eliminates the need for large depth of field or long focal lengths enabling smaller, more portable devices. In addition, the low cost implementation of plenoptic or focus stacking cameras eliminates the cost of variable lenses to increase the depth of field, either using voltage controlled liquid lenses or deformable mirrors.

### Scars, Marks, And Tattoos

The ability to capture multiple views at varying planes of focus with multiple viewing angles has major advantages for images containing Scars, Marks, and Tattoos (SMT) captured in a surveillance situation. Two methods are described for the solution.

The ability to optimize the image of a subject of interest enhancing clarity of features by combining views from multiple focal planes into an enhanced image.

The ability to optimize the image of a subject of interest enhancing clarity of features by combining views from multiple viewing angles of the face.

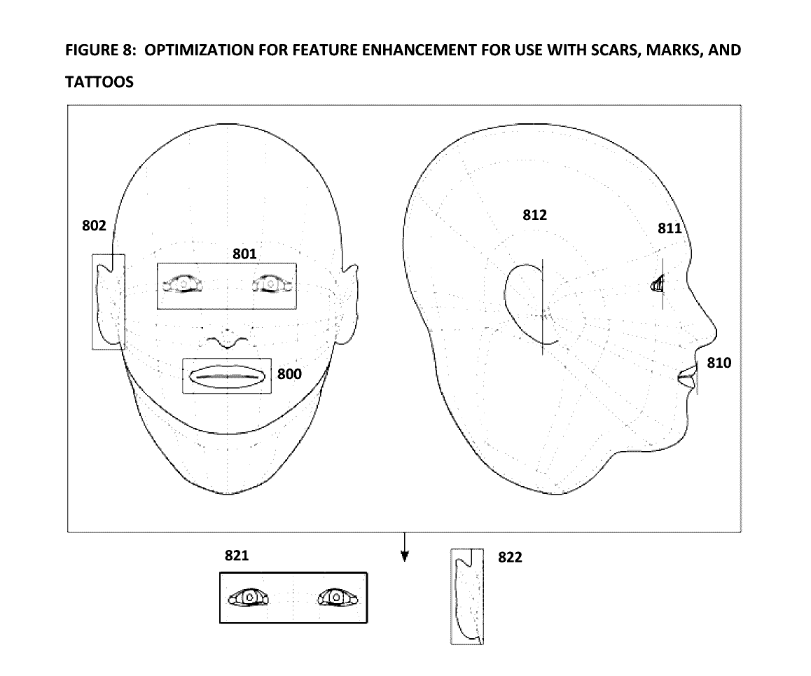

FIG. 8 shows the method whereby features of captured images can be optimized through the use of multiple views to enhance the focus of each particular feature. Combining those views that are in focus results in a single image resulting in an enhanced image of the individual. Scars, Marks, Tattoos, and Skin Texture images can be enhanced in a similar manner by combining multiple views containing different planes of focus into a single optimal biometric image. When the initial view selected has one feature 800 that is at a plane of focus 810 that is in focus and other features 801, 802 at planes of focus 811, 812 that are not clear, sequencing through views that contain planes of focus 811, 812 results in images of those features 821, 822 which are in focus. Combining the enhanced views of each feature results in a single image optimized for Scars, Marks, Tattoos, and Skin Texture analysis.

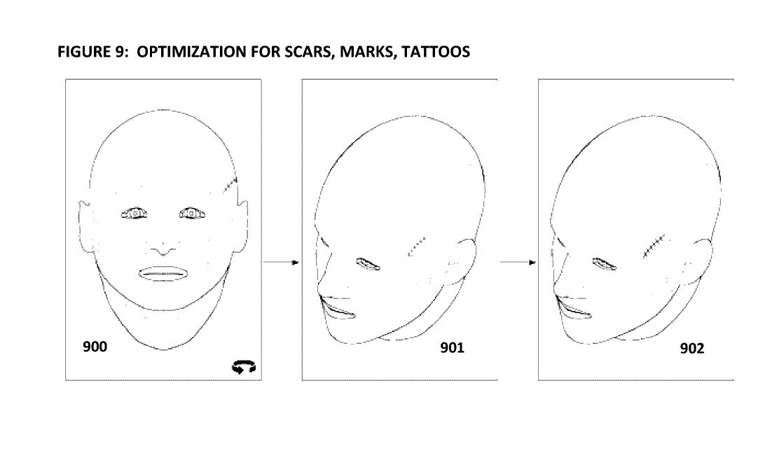

FIG. 9 shows the method whereby features of captured images can be optimized through the use of multiple views including additional viewing angles to increase information for three dimensional capture of the image. Scars, Marks, Tattoos, and Skin Texture images can be enhanced by combining multiple views containing information from different angles of view and including this information in a single optimized image. When the initial view selected shows a full frontal view 900 of the face, other views can be selected to show a view 901 of the individual with slight rotation of the face and enhance the focus 902 of the feature of interest, in this case the Scar.

Current surveillance systems currently estimate the three dimensional representation of a face using mirroring or other estimation techniques to generate the missing information. Plenoptic or focus stacking cameras enable the use of multiple views with independent angles of view to construct an image that provides a more complete three dimensional representation of the face based on actual images rather than mirroring.

The use of plenoptic or focus stacking cameras to effectively increase the depth of field of a camera by using a single image with multiple views at varying planes of focus is also applicable to processing of tattoos, the tattoo to be captured is located in an image and multiple views with varying planes of focus are identified to bracket the tattoo. By sequencing through the views an operator is able to select the single plane which best meets image quality.

The ability to sequence through multiple views from a single image captured with the plenoptic or focus stacking camera eliminates the need to move or relocate the capture device or have the subject relocate to the optimal plane of focus in order to capture the tattoo. This increases officer efficiency at booking stations and prevents complexity of the equipment needed to capture tattoos.

1. A method of optimizing a single image of a biometric parameter, comprising:
capturing an image of the biometric parameter having at least one of image portions that are in different focal planes and image portions that are viewable from different viewing angles;
forming a single image includes forming multiple views of the biometric parameter wherein each one of the multiple views comprises a different combination of at least one of a focal plane and a viewing angle; and
processing the multiple views to create a single improved image of the biometric parameter with the image portions all in focus and including information from multiple viewing angles.

2. The method of claim 1, wherein forming each one of the multiple views include a different combination of a focal plane and a viewing angle.

3. The method of claim 1, further including processing the image on a device forming the single image.

4. The method of claims 1, further including processing the image on one of a stand-alone device, computer, and workstation.

5. The method of claim 1, further including processing of the biometric image captured to determine the areas of the image which are in focus for each of the views;
storing the portion of the image which is in focus for each view on the device; and
processing the stored images to form a single image of the biometric with the optimal in focus information available.

6. The method of claim 1, further including processing of the biometric image captured to determine the areas available of the image which provide a different viewing angle of the biometric;
storing the portions of the image available from each view with different viewing angles;
processing the portions of each stored view that is in focus; and
processing the portions of each view that is in focus from each of the viewing angles to provide an image of the biometric from viewing angles that extend beyond the perpendicular view of the biometric.

7. The method of claim 1, wherein the method includes using a plenoptic camera for capturing the single image.

8. The method of claim 1, wherein the method includes using a focus stacking camera for capturing the single image.

9. The method of claim 1, wherein a single fingerprint is the biometric image captured and optimized using at least one of image portions that are in different focal planes and image portions that are viewable from different viewing angles.

10. The method of claim 1, wherein multiple fingerprints are the biometric image captured and optimized using at least one of image portions that are in different focal planes and image portions that are viewable from different viewing angles.

11. The method of claim 10, wherein an image is captured of multiple fingerprints further including processing of the biometric image to determine the location of each of the fingers in the image;
processing each fingerprint to determine the view with the fingerprint in focus;
storing the view with the fingerprint in focus on the device; and
processing all stored fingerprint images to combine the saved fingerprints into one biometric image.

12. The method of claim 1, wherein palm prints are the biometric image captured and optimized using at least one of image portions that are in different focal planes and image portions that are viewable from different viewing angles.

13. The method of claim 1, wherein iris images are the biometric image captured and optimized using at least one of image portions that are in different focal planes and image portions that are viewable from different viewing angles.

14. The method of claim 1, wherein at least one of scars, marks, tattoos, and skin texture are the biometric image captured and optimized using at least one of image portions that are in different focal planes and image portions that are viewable from different viewing angles.

15. The method of claim 1, wherein capturing the biometric image is performed in the near infrared spectrum.
